(19) United States
(12) Patent Application Publication
(10) Pub. No.: US 2010/0068536 A1
(43) Pub. Date: Mar. 18, 2010

(54) OPTICAL ELEMENT AND OPTICAL DEVICE INCLUDING THE SAME

(75) Inventor: Daisuke Sano, Utsunomiya-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/560,009

(22) Filed: Sep. 15, 2009

(30) Foreign Application Priority Data
Sep. 16, 2008 (JP) 2008-236311

(51) Int. Cl. B32B 17/06

(52) U.S. Cl. 428/432

(57) ABSTRACT

In an optical element produced by being immersed in hot water at a temperature in the range of 60° C. to 85° C. for 10 minutes or more, the optical element includes a glass substrate, wherein water resistance and acid resistance of a material constituting the glass substrate satisfies a predetermined conditional expression.

### BACKGROUND OF THE INVENTION

1. Field of the Invention

The present invention relates to an optical element produced through an immersion treatment in hot water, and in particular, to water resistance and acid resistance of a glass substrate constituting an optical element.

2. Description of the Related Art

An optical film such as an antireflection coating film is formed on an optical element such as an imaging lens. In a process of producing such an optical element, an immersion treatment in hot water may be performed.

For example, Japanese Patent Laid-Open Nos. 2005-275372 and 2007-241177 disclose methods of obtaining an antireflection coating film including immersing an optical element having an alumina film thereon in hot water to form a fine textured structure on a surface of the alumina film.

Japanese Patent Laid-Open No. 2008-129311 discloses a method of forming a porous SiO₂ film having good laser resistance including immersing an optical element having a SiO₂ film thereon in hot water.

However, in the above patent documents, an effect of the immersion treatment in hot water on a glass substrate is not considered. Consequently, the surface of the glass substrate may be corroded in some types of glass substrates, resulting in a problem of the generation of scattered light.

### SUMMARY OF THE INVENTION

The present invention provides an optical element that undergoes a hot-water treatment in a production process thereof wherein corrosion of a glass substrate can be prevented.

According to an optical element of the present invention, the optical element is produced by being immersed in hot water at a temperature in the range of 60° C. to 85° C. for 10 minutes or more and includes a glass substrate and an optical film disposed on the glass substrate. In this optical element, when a is an integer of 1 to 6 corresponding to each class of water resistance measured by a powder method and b is an integer of 1 to 6 corresponding to each class of acid resistance measured by a powder method, the water resistance and acid resistance being specified in Japanese Optical Glass Industrial Standards, a material constituting the glass substrate satisfies the relationship a×b<6.

According to the optical element of the present invention, corrosion of a glass substrate due to an immersion treatment of the optical element in hot water can be prevented.

Further features of the present invention will become apparent from the following description of exemplary embodiments with reference to the attached drawings.

### BRIEF DESCRIPTION OF THE DRAWINGS

FIG. 1 is a schematic view showing an optical element including a glass substrate that satisfies conditional expression (1) of the present invention.

FIG. 2 is a schematic view showing an optical element including a glass substrate that does not satisfy conditional expression (1) of the present invention.

FIG. 3 is a cross-sectional view of an optical element including an optical film on which a textured structure is provided.

### DESCRIPTION OF THE EMBODIMENTS

Various embodiments of the present invention will now be described in detail with reference to the attached drawings.

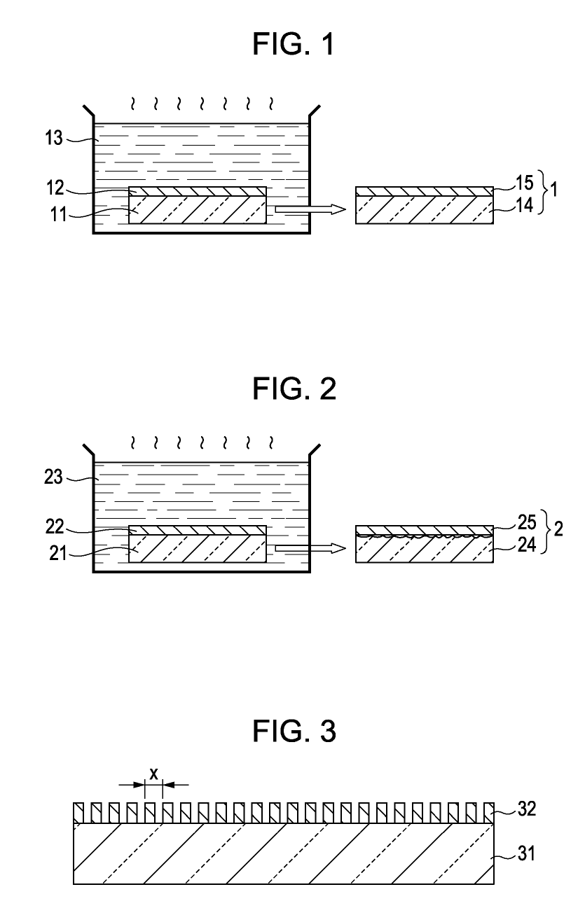

FIG. 1 is a view showing a basic structure of an optical element 1 of the present invention. In FIG. 1, reference numeral 11 indicates a glass substrate, reference numeral 12 indicates an optical film formed on a surface of the glass substrate 11, reference numeral 13 indicates hot water at a temperature in the range of 60° C. to 85° C., reference numeral 14 indicates the glass substrate after a hot-water treatment, and reference numeral 15 indicates the optical film after the hot-water treatment.

In the present invention, the temperature of the hot water 13 during the immersion treatment in hot water is controlled to be in the range of 60° C. to 85° C. If the temperature of the hot water 13 is lower than 60° C., the temperature of the hot water 13 is too low and a fine textured structure cannot be formed on a surface of the optical film. On the other hand, if the temperature of the hot water 13 exceeds 85° C., air bubbles are generated in the hot water 13, thereby destabilizing the formation of a fine textured structure. The temperature of the hot water may be in the range of 65° C. to 80° C., and in particular, in the range of 70° C. to 75° C.

Furthermore, when a is an integer of 1 to 6 corresponding to each class of water resistance measured by a powder method and b is an integer of 1 to 6 corresponding to each class of acid resistance measured by a powder method, the water resistance and acid resistance being specified in Japanese Optical Glass Industrial Standards (JOGIS), the following conditional expression (1) is satisfied:

a×b<6 (1)

The water resistance measured by the powder method, which is specified in JOGIS is determined as follows: A crushed powder having a particle diameter in the range of 425 to 600 μm is placed in a platinum basket, and the platinum basket is immersed in 80 mL of pure water (pH=6.5 to 7.5) in a round-bottom flask made of quartz glass. The powder in the platinum basket is then treated in a boiling water bath for 60 minutes, and a decrease in the mass (weight percent) is measured. When the decrease in the mass is less than 0.05 weight percent, a=1. When the decrease in the mass is 0.05 weight percent or more and less than 0.10 weight percent, a=2. When the decrease in the mass is 0.10 weight percent or more and less than 0.25 weight percent, a=3. When the decrease in the mass is 0.25 weight percent or more and less than 0.60 weight percent, a=4. When the decrease in the mass is 0.60 weight percent or more and less than 1.10 weight percent, a=5. When the decrease in the mass is 1.10 weight percent or more, a=6.

The acid resistance measured by the powder method, which is specified in JOGIS is determined as follows: A crushed powder having a particle diameter in the range of 425 to 600 μm is placed in a platinum basket, and the platinum basket is immersed in a 0.01 mol/L nitric acid aqueous solution in a round-bottom flask made of quartz glass. The powder in the platinum basket is then treated in a boiling water bath for 60 minutes, and a decrease in the mass (weight percent) is measured. When the decrease in the mass is less than 0.20 weight percent, b=1. When the decrease in the mass is 0.20 weight percent or more and less than 0.35 weight percent, b=2. When the decrease in the mass is 0.35 weight percent or more and less than 0.65 weight percent, b=3. When the decrease in the mass is 0.65 weight percent or more and less than 1.20 weight percent, b=4. When the decrease in the mass is 1.20 weight percent or more and less than 2.20 weight percent, b=5. When the decrease in the mass is 2.20 weight percent or more, b=6.

By satisfying conditional expression (1), corrosion of the glass substrate 14 due to an immersion treatment in hot water can be prevented regardless of the type of optical film. In the immersion treatment in hot water, elution and corrosion of components of the optical film 12 and the glass substrate 11 occur. Accordingly, it is necessary for an optical element that undergoes a hot-water treatment to select a substrate 11 having high water resistance and acid resistance.

As a comparative example, a case where a glass substrate in which the numerical value of the product (a×b) of the water resistance (a) and acid resistance (b) is 6 or more is used will be described with reference to FIG. 2. In FIG. 2, reference numeral 21 indicates a glass substrate, reference numeral 22 indicates an optical film formed on a surface of the glass substrate 21, reference numeral 23 indicates hot water at a temperature in the range of 60° C. to 85° C., reference numeral 24 indicates the glass substrate after a hot-water treatment, and reference numeral 25 indicates the optical film 22 after the hot-water treatment. Even though the optical film 22 is provided in this manner, the surface of the glass substrate 24 is corroded by the immersion treatment in hot water. The corrosion of the glass substrate 24 becomes more significant as the numerical value of the product (a×b) of the water resistance (a) and acid resistance (b) increases further beyond 6. The surface of the glass substrate 24 on which the optical film 25 is not formed is also corroded by such an immersion treatment in hot water.

As described above, for an optical element produced through an immersion treatment in hot water, corrosion of a glass substrate can be prevented by using a glass substrate that satisfies conditional expression (1) and providing the hot water at a temperature in the range of 60° C. to 85° C.

In the embodiments of the present invention, an optical film (antireflection coating film) having a fine textured structure is formed by combining a film formation by a sol-gel method with an immersion treatment in hot water. The sol-gel method is a method of forming an optical film including applying a solution in a sol state onto a surface of a glass substrate and gelating the solution by baking. In this method, pores are readily formed in the optical film in a step of evaporating a solvent in the solution during baking. Accordingly, in an optical element produced by a method including a step of forming a film by a sol-gel method, the surface of a glass substrate is readily exposed to any corrosive force of a surrounding liquid medium, and thus the problem described above tends to occur if the present invention is not applied. However, if the present invention is applied, even if the optical film has pores, the glass substrate resists corrosion during hot-water treatment, and the advantages of the present invention can be significantly achieved.

In the embodiments, a textured structure having an average interval equal to or less than the wavelength of visible light is formed on a surface of an optical film by an immersion treatment in hot water. For example, when a glass substrate having an alumina film formed by a sol-gel method or vacuum deposition is immersed in hot water at 60° C. or higher for ten minutes or more, elution in the hot water and recrystallization occur on a surface of the alumina film to form a textured structure having an average interval in the range of about 20 to 200 nm. In this manner, a structure having an average interval equal to or less than the wavelength of visible light (400 to 700 nm) is formed by the immersion treatment in hot water.

A textured structure of an optical film will be described with reference to FIG. 3. In FIG. 3, reference numeral 31 indicates a glass substrate and reference numeral 32 indicates an optical film on which a textured structure having an average interval equal to or less than the wavelength of visible light is provided. Although a periodic structure is exemplified in FIG. 3, an interval of the textured structure may be aperiodic as long as the average interval of the textured structure is equal to or less than a wavelength to be used. The thickness of the optical film may be equal to or more than the wavelength to be used. As the optical film 32 having the textured structure, a structure composed of a single material and air is exemplified. Alternatively, the textured structure may be composed of a plurality of materials having different refractive indices.

The interval of the textured structure is defined as the interval represented by x in FIG. 3, and refers to the interval between corresponding positions of adjacent projections or adjacent depressions.

The textured structure of the optical film in each of the embodiments has an average interval equal to or less than the wavelength of visible light, and such an optical film has a function similar to that of a flat film having a refractive index corresponding to a filling rate of the textured structure for visible light.

In the case where the optical film 32 having such a textured structure is produced by an immersion treatment in hot water, the hot water readily reaches the substrate as compared with a normal optical film. Accordingly, the problem described above tends to occur if the present invention is not applied. However, if the present invention is applied, even when hot water reaches the substrate, the glass substrate resists corrosion during hot-water treatment, and advantages of the present invention can be significantly achieved.

In a first additional example of the present invention, an S-LAH55 substrate manufactured by OHARA Inc. was used as a glass substrate. As for water resistance and acid resistance of the S-LAH55 substrate, a=1 and b=3, respectively. Accordingly, the S-LAH55 substrate is composed of a material that satisfies conditional expression (1).

An alumina film was formed on the glass substrate by a sol-gel method, and the glass substrate was then immersed in hot water at 75° C. for 20 minutes, and dried at 60° C. for 15 minutes. When the surface of the alumina film was observed, it was confirmed that a textured structure having an average interval of about 80 nm was formed. Corrosion of the glass substrate was not observed.

In a second additional example of the present invention, an S-LAH60 substrate manufactured by OHARA Inc. was used as a glass substrate. As for water resistance and acid resistance of the S-LAH60 substrate, a=1 and b=3, respectively. Accordingly, the S-LAH60 substrate is composed of a material that satisfies conditional expression (1).

A SiTi mixed film was formed on the glass substrate by a sol-gel method, and an alumina film was then formed on the surface of the SiTi mixed film by a sol-gel method. The glass substrate was then immersed in hot water at 80° C. for 30 minutes, and dried at 60° C. for 15 minutes. When the surface of the alumina film was observed, it was confirmed that a textured structure having an average interval of about 70 nm was formed. Corrosion of the glass substrate was not observed.

In a third additional example of the present invention, an FDS90 substrate manufactured by HOYA Corporation was used as a glass substrate. As for water resistance and acid resistance of the FDS90 substrate, a=2 and b=1, respectively. Accordingly, the FDS90 substrate is composed of a material that satisfies conditional expression (1).

A SiO₂ film was formed on the glass substrate by a vacuum evaporation method, and the glass substrate was then immersed in hot water at 85° C. for 270 minutes, and dried at 120° C. for 15 minutes. When the surface of the SiO₂ film was observed, it was confirmed that a nanoporous structure was formed. Corrosion of the glass substrate was not observed.

In an additional comparative example, an S-FSL5 substrate manufactured by OHARA Inc. was used as a glass substrate. As for water resistance and acid resistance of the S-FSL5 substrate, a=3 and b=4, respectively. Accordingly, the S-FSL5 substrate is composed of a material that does not satisfy conditional expression (1).

An alumina film was formed on the glass substrate by a sol-gel method, and the glass substrate was then immersed in hot water at 85° C. for 30 minutes, and dried at 60° C. for 15 minutes. When the surface of the resulting optical element was observed, it was confirmed that a textured structure having an average interval of about 80 nm was formed. Dimming was partly observed on the surface of the glass substrate.

With respect to the above examples of the present invention, a description has been made of an optical element including an optical film on which a textured structure having an average interval equal to or less than the wavelength of visible light (400 to 700 nm) is formed. Alternatively, for an optical element used in an optical system using infrared light or ultraviolet light, for example, the average interval of the textured structure can be controlled to be equal to or less than the wavelength to be used.

While the present invention has been described with reference to exemplary embodiments, it is to be understood that the invention is not limited to the disclosed exemplary embodiments. The scope of the following claims is to be accorded the broadest interpretation so as to encompass all modifications and equivalent structures and functions.

This application claims the benefit of Japanese Patent Application No. 2008-236311 filed Sep. 16, 2008, which is hereby incorporated by reference herein in its entirety.

What is claimed is:

1. An optical element produced by being immersed in hot water at a temperature in the range of 60° C. to 85° C. for 10 minutes or more, the optical element comprising:
a glass substrate; and
an optical film disposed on the glass substrate,
wherein when a is an integer of 1 to 6 corresponding to each class of water resistance measured by a powder method and b is an integer of 1 to 6 corresponding to each class of acid resistance measured by a powder method, the water resistance and acid resistance being specified in Japanese Optical Glass Industrial Standards, a material constituting the glass substrate satisfies the relationship a×b<6.

2. The optical element according to claim 1, wherein the optical film is composed of alumina.

3. The optical element according to claim 1, wherein the optical film includes a textured structure having an average interval equal to or less than the wavelength of visible light on a surface thereof, the textured structure being formed by the immersion treatment in hot water.

4. The optical element according to claim 1, wherein the optical film is an antireflection coating film.

5. An optical device comprising the optical element according to claim 1.
